(19) United States
(12) Patent Application Publication
(10) Pub. No.: US 2007/0086093 A1
(43) Pub. Date: Apr. 19, 2007

(54) Lens device for image projection apparatus

(75) Inventors: Ming-Tsun Hung, Chu Nan (TW); Chih-Chung Yang, Chu Nan (TW)

Correspondence Address: DAVIDSON BERQUIST JACKSON & GOWDEY LLP, 4300 WILSON BLVD., 7TH FLOOR, ARLINGTON, VA, 22203, US

(73) Assignee: CORETRONIC CORPORATION, Chu Nan (TW)

(21) Appl. No.: 11/521,443

(22) Filed: Sep. 15, 2006

(30) Foreign Application Priority Data
Oct. 17, 2005 (TW) 094136170

(51) Int. Cl. G02B 15/14

(52) U.S. Cl. 359/676

(57) ABSTRACT

A lens device includes a lens unit that is connected fixedly to a coupling ring disposed coaxially in and coupled axially and movably to a hollow tubular body of a lens seat. A radially extending engaging stub of the coupling ring engages movably with a slot that is formed in the tubular body and that extends in an axial direction of the lens seat, and engages movably with a curved guiding groove in an operating sleeve sleeved rotatably on the tubular body. Movement of the engaging stub along the guiding groove in the operating sleeve in response to rotation of the operating sleeve relative to the tubular body causes the engaging stub on the coupling ring to move along the slot in the tubular body in the axial direction, thereby adjusting the lens unit to a desired focusing position.

### CROSS-REFERENCE TO RELATED APPLICATION

This application claims priority of Taiwanese Application No. 094136170, filed on Oct. 17, 2005.

### BACKGROUND OF THE INVENTION

1. Field of the Invention

The invention relates to a lens device, more particularly to a manually adjustable lens device for an image projection apparatus.

2. Description of the Related Art

Referring to FIG. 1, a conventional lens device for an image projection apparatus is shown to include a lens seat 4, a lens unit 5, and a sleeve ring 7. The lens unit 5 is mounted on one end of the lens seat 4, and includes a cylindrical housing 50 housed with a lens set 51 and formed with a plurality of guiding grooves 52. The lens set 51 is mounted with a plurality of driven protrusions 54, such as screws, engaging respectively with the guiding grooves 52 in the housing 50.

In use, a driving mechanism (not shown), such as a motor unit, is operable so as to drive the driven protrusions 54 to move respectively along the guiding grooves 52 in accordance with an electrical control signal, thereby adjusting the lens unit 5 to a desired focusing position. Since the driving mechanism is required for moving the lens unit 5, higher costs are incurred.

### SUMMARY OF THE INVENTION

Therefore, the object of the present invention is to provide a lens device that has a relatively simple construction and low cost.

According to the present invention, a lens device comprises a lens seat, a lens unit and an operating sleeve. The lens seat comprises a hollow tubular body that extends in an axial direction of the lens seat and that has a front end portion, and a coupling ring disposed coaxially in the tubular body and coupled axially and movably to the front end portion of the tubular body. The front end portion of the tubular body is formed with a slot extending in the axial direction, and the coupling ring has an annular outer surface formed with a radially extending engaging stub that engages movably with the slot in the front end portion of the tubular body. The lens unit is disposed in the tubular body and connected fixedly to the coupling ring of the lens seat. The operating sleeve sleeves rotatably on the tubular body of the lens seat and is formed with a curved guiding groove. The engaging stub on the coupling ring of the lens seat engages movably with the guiding groove in the operating sleeve.

Movement of the engaging stub along the guiding groove in the operating sleeve in response to rotation of the operating sleeve relative to the tubular body of the lens seat causes the engaging stub on the coupling ring to move along the slot in the front end portion of the tubular body in the axial direction, thereby adjusting the lens unit to a desired focusing position.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view of a conventional lens device;

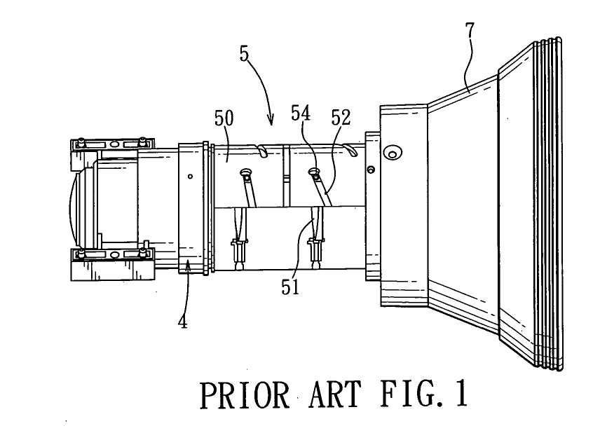

FIG. 2 is a partly exploded perspective view of a lens device according to a preferred embodiment of the present invention;

FIG. 3 is a partly cutaway schematic view showing when a lens unit is moved to a focusing position according to the preferred embodiment of the present invention; and

FIG. 4 is a partly cutaway schematic view showing when the lens unit is moved to another focusing position according to the preferred embodiment of the present invention.

### DETAILED DESCRIPTION OF THE PREFERRED EMBODIMENT

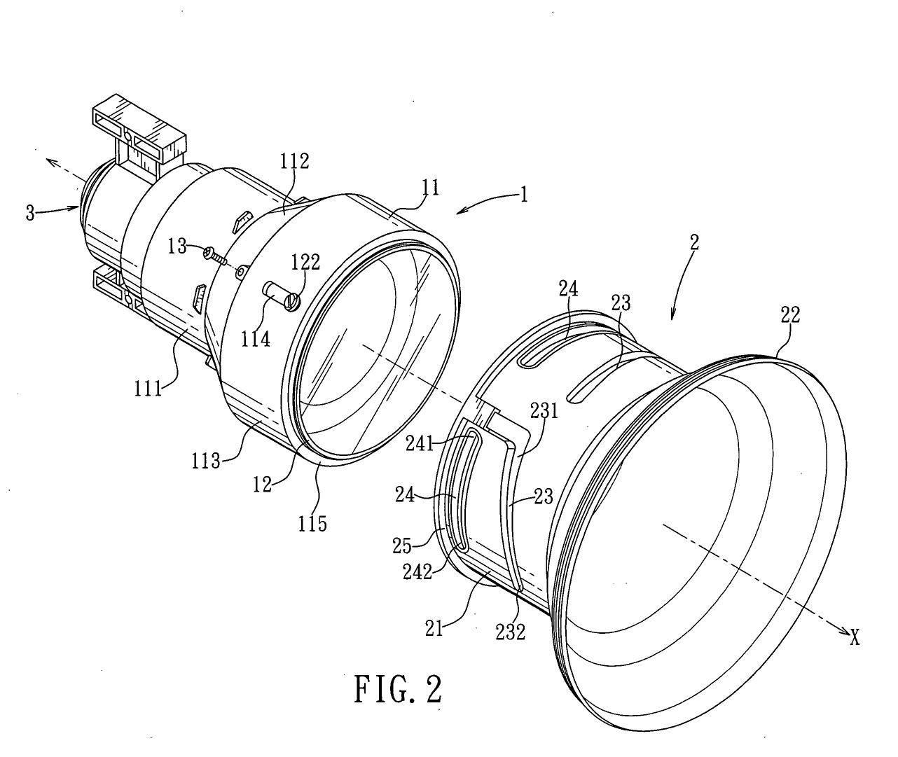

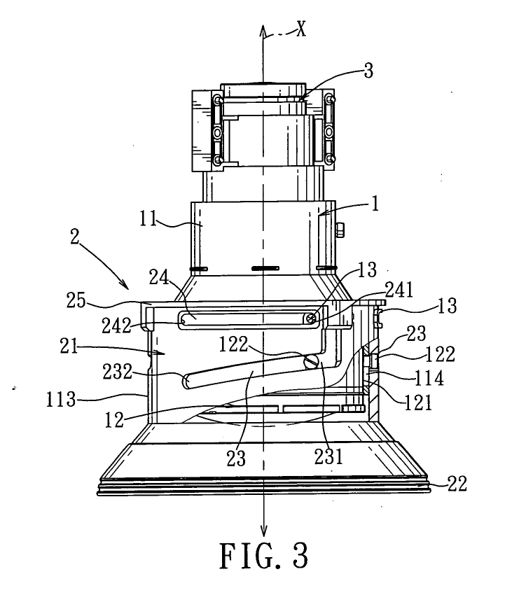

Referring to FIGS. 2 and 3, the preferred embodiment of a lens device according to the present invention is shown to include a lens seat 1, a lens unit 3, and an operating sleeve 2. In this embodiment, the lens device is adapted for use within an image projection apparatus (not shown).

The lens seat 1 includes a hollow tubular body 11 and a coupling ring 12. The tubular body 11 extends in an axial direction (X) of the lens seat 1, and has opposite front and rear end portions 113, 111 and an intermediate portion 112 interconnecting the front and rear end portions 113, 111. In this embodiment, the front end portion 113 of the tubular body 11 has an outer diameter greater than that of the rear end portion 111 of the tubular body 11. The front end portion 113 of the tubular body 11 is formed with three slots 114 (only one is illustrated in FIG. 2) extending in the axial direction (X) and spaced equally apart from each other in a circumferential direction. In this embodiment, the intermediate portion 112 of the tubular body 11 has three radially and outwardly extending positioning members 13 (only one is illustrated in FIG. 2) that are aligned respectively with the slots 114 in the front end portion 113 of the tubular body 11. The positioning members 13 are in the form of screw fasteners.

The coupling ring 12 is disposed coaxially in the tubular body 11, and is coupled axially and movably to the front end portion 113 of the tubular body 11. The coupling ring 12 has an annular outer surface 121 formed with three radially extending engaging stubs 122 that engage respectively and movably with the slots 114 in the front end portion 113 of the tubular body 11.

The lens unit 3 is disposed in the tubular body 11, and is connected fixedly to the coupling ring 12 of the lens seat 1. In this embodiment, the lens unit 3 consists of a plurality of lenses (not shown).

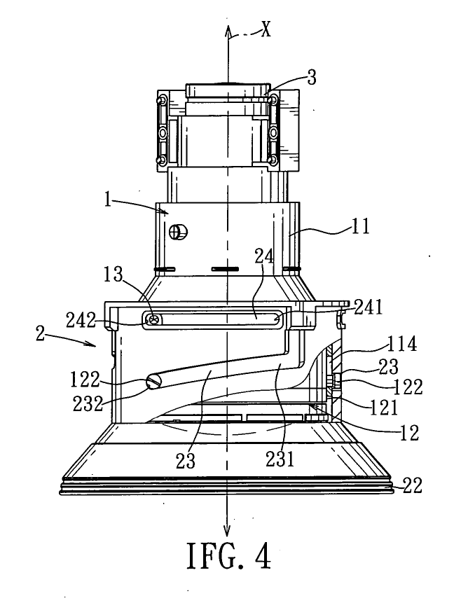

The operating sleeve 2 is sleeved rotatably on the tubular body 11 of the lens seat 1, and has a rear end 25, and an expanded front end 22. The operating sleeve 2 is formed with curved guiding grooves 23 (only two are illustrated in FIG. 2) that are distal from the rear end 25 of the operating sleeve 2. The engaging stubs 122 on the coupling ring 12 of the lens seat 1 engage respectively and movably with the guiding grooves 23 in the operating sleeve 2. In this embodiment, the operating sleeve 2 is further formed with three circumferentially extending positioning grooves 24 (only two are illustrated in FIG. 2). The positioning members 13 on the intermediate portion 112 of the tubular body 11 of the lens seat 1 engage respectively and movably with the positioning grooves 24 in the operating sleeve 2. In this embodiment, each of the positioning grooves 24 has opposite first and second ends 241, 242. For each positioning groove 24, a length between the first and second ends 241, 242 is not greater than that of a corresponding one of the guiding grooves 23 in a circumferential direction. In such a configuration, with further reference to FIGS. 3 and 4, each engaging stub 122 on the coupling ring 12 is movable along a corresponding one of the guiding grooves 23 in the operating sleeve 2 from a first limit position 231 to a second limit position 232 while each positioning member 13 moves along a corresponding one of the positioning grooves 24 in the operating sleeve 2 from the first end 241 to the second end 242, wherein the first and second ends 241, 242 of each positioning groove 24 are aligned respectively with the first and second limit positions 231, 232 of a corresponding one of the engaging stubs 122 and wherein a distance between the first and second limit positions 231, 232 of each engaging stub 122 in the axial direction (X) is substantially equal to a length of each slot 114 in the front end portion 113 of the tubular body 11 of the lens seat 1. In this embodiment, the second limit position 232 is at one end of each guiding groove 23, as shown in FIG. 3.

In use, movement of each engaging stub 122 along the corresponding guiding groove 23 in the operating sleeve 2 in response to rotation of the operating sleeve 2 relative to the tubular body 11 of the lens seat 1 by manual operation causes each engaging stub 122 on the coupling ring 12 to move along the corresponding slot 114 in the front end portion 113 of the tubular body 11 in the axial direction (X), thereby adjusting the lens unit 3 to a desired focusing position.

In sum, the lens unit 3 can be moved to the desired focusing position by manually rotating the operating sleeve 2 relative to the lens seat 1 without the need for the driving mechanism used in the aforesaid conventional lens device. Therefore, the lens device of this invention has a relatively simple construction, and can be fabricated at a relatively low cost.

While the present invention has been described in connection with what is considered the most practical and preferred embodiment, it is understood that this invention is not limit to the disclosed embodiment but is intended to cover various arrangements included within the spirit and scope of the broadest interpretation so as to encompass all such modifications and equivalent arrangements.

We claim:

1. A lens device comprising:
a lens seat comprising a hollow tubular body that extends in an axial direction of said lens seat and that has a front end portion, and a coupling ring disposed coaxially in said tubular body and coupled axially and movably to said front end portion of said tubular body, said front end portion of said tubular body being formed with a slot extending in the axial direction, said coupling ring having an annular outer surface formed with a radially extending engaging stub that engages movably with said slot in said front end portion of said tubular body;
a lens unit disposed in said tubular body and connected fixedly to said coupling ring of said lens seat; and
an operating sleeve sleeved rotatably on said tubular body of said lens seat and formed with a curved guiding groove, said engaging stub on said coupling ring of said lens seat engaging movably with said guiding groove in said operating sleeve;
wherein movement of said engaging stub along said guiding groove in said operating sleeve in response to rotation of said operating sleeve relative to said tubular body of said lens seat causes said engaging stub on said coupling ring to move along said slot in said front end portion of said tubular body in the axial direction, thereby adjusting said lens unit to a desired focusing position.

2. The lens device as claimed in claim 1, wherein said guiding groove in said operating sleeve has opposite first and second ends, a distance between said first and second ends in the axial direction being substantially equal to a length of said slot in said front end portion of said tubular body.

3. The lens device as claimed in claim 1, wherein said operating sleeve is further formed with a circumferentially extending positioning groove, said tubular body being provided with a radially and outwardly extending positioning member that engages movably with said positioning groove in said operating sleeve.

4. The lens device as claimed in claim 3, wherein said positioning groove in said operating sleeve has opposite first and second ends, a length between said first and second ends of said positioning groove in said operating sleeve being not greater than that of said guiding groove in said operating sleeve in a circumferential direction, said engaging stub on said coupling ring being movable along said guiding groove in said operating sleeve from a first limit position to a second limit position while said positioning member moves along said positioning groove in said operating sleeve from said first end to said second end.

5. The lens device as claimed in claim 4, wherein a distance between said first and second limit positions of said engaging stub in the axial direction is substantially equal to a length of said slot in said front end portion of said tubular body.

6. The lens device as claimed in claim 3, wherein said positioning member on said tubular body of said lens seat is aligned with said slot in said front end portion of said tubular body of said lens seat along the axial direction.

7. The lens device as claimed in claim 3, wherein said operating sleeve has a rear end, said positioning groove being disposed adjacent to said rear end, said guiding groove being distal from said rear end.
